(19) United States
(12) Patent Application Publication
(10) Pub. No.: US 2024/0299142 A1
(43) Pub. Date: Sep. 12, 2024

(54) METHOD FOR DIGITALLY PRODUCING PARTIAL PROSTHESES

(71) Applicant: Ivoclar Vivadent AG, Schaan (LI)

(72) Inventor: Ronny Watzke, Feldkirch (AT)

(21) Appl. No.: 18/597,500

(22) Filed: Mar. 6, 2024

(30) Foreign Application Priority Data
Mar. 9, 2023 (EP) 23160935.5

(51) Int. Cl. A61C 13/00; B33Y 30/00; B33Y 50/02; B33Y 80/00

(52) U.S. Cl. CPC A61C 13/0004; A61C 13/0019; B33Y 30/00; B33Y 50/02; B33Y 80/00

(57) ABSTRACT

A production system (100) for producing partial prostheses (101), with a user interface (103) for digitally designing a prosthesis framework (105) with coupling elements (119) to the residual tooth hard tissue, a prosthesis base (107) and prosthesis teeth (109).

### CROSS-REFERENCE TO RELATED APPLICATIONS

This application claims priority to EP 23160935.5, filed on Mar. 9, 2023, the disclosure of which is incorporated herein by reference in its entirety.

### TECHNICAL FIELD

The present invention relates to a production system for digitally producing partial prostheses, a production method for digitally producing partial prostheses.

### BACKGROUND

Partial prostheses consist of several parts and different materials. The extent or size of the partial prostheses depends on the presence of teeth in the patient's mouth. Compared to total edentulism, the dental situation can vary individually in terms of the number and extent of gaps. The production of partial prostheses is time-consuming and error-prone due to the large number of materials and work steps involved.

Currently, several models are required for the conventional production of partial prostheses. The metal framework is conventionally created using an investment model, modeled and cast. The metal framework is then applied to the master model. Wax modeling of the gingival portions and tooth set-up is then performed in the articulator. A lost-wax procedure is then used to complete the partial prosthesis, for example, in which gingiva-colored plastic is injected instead of the wax. Modeling the gingival and tooth portions in wax and transferring them is error-prone and time-consuming.

The partial prosthesis is then finished in the articulator with an occlusion check, the so-called primary reassembly.

After removal of the partial prosthesis from the articulator, it is finally finished and polished. This procedure is also time-consuming and working with several models can lead to transfer errors.

US 20180042708 and U.S. Pat. No. 10,959,818 are directed to computer assisted design and manufacturing of removable partial dentures and are hereby incorporated by reference. US 2021298881 is directed to a removable partial denture and is hereby incorporated by reference.

### SUMMARY

It is the technical task of the invention to simplify the production of partial prostheses.

This technical task is solved by subject matter according to the independent claims. Technically advantageous embodiments are the subject matter of the dependent claims, the description and the drawings.

According to a first aspect, the technical task is solved by a production system for digitally producing partial prostheses, with a user interface for digitally designing a prosthesis framework with coupling elements to the residual tooth hard tissue, a prosthesis base and prosthesis teeth. The production system may be formed by software that combines all the design elements for the components of the partial prosthesis. For example, the coupling elements are formed by double crowns (telescopes), attachments, anchors, clasps, magnets and/or bars. By assembling the individual elements in the correct position, the complexity is reduced.

In a technically advantageous embodiment of the production system, the production system comprises a production device for automatically producing the prosthesis framework, the prosthesis base and/or the prosthesis teeth. This provides the technical advantage, for example, that after a final polishing, the finished partial prosthesis can be delivered immediately to the dentist for insertion into the patient's dentition.

In another technically advantageous embodiment of the production system, the production device is configured to produce the prosthesis framework, the prosthesis base and/or the prosthesis teeth by means of an additive and/or subtractive production process.

In another technically advantageous embodiment of the production system, the production device comprises a first production unit for producing the prosthesis framework and a second production unit for producing the prosthesis base and/or the prosthesis teeth, or the production device is configured to produce the prosthesis framework, the prosthesis base and/or the prosthesis teeth by means of a single production unit. The first production unit may use a first production method, and the second production unit may use a second production method. The first and second production methods may be different. This provides the technical advantage, for example, that a particularly suitable production unit can be used depending on the component to be produced.

In another technically advantageous embodiment of the production system, the production system comprises an export interface for exporting data of the designed prosthesis framework, the designed prosthesis base and/or the designed prosthesis teeth. This provides the technical advantage, for example, that the data on the individual components can be further processed by other devices.

In another technically advantageous embodiment of the production system, the production system is configured to digitally design a positioning system for positioning the prosthesis framework, the prosthesis base and/or the prosthesis teeth relative to each other via the user interface. This can be done manually by the dental technician or automated via the software. The intraoral patient situation for the digital design of the above-mentioned components is made available to the software either by means of an intraoral scan or a scan of a tooth model. The tooth model is obtained by means of an impression of the patient; this is used in particular for patients with very few teeth. The data from the intraoral scan can be used to produce a model on which the individual elements can be assembled. This provides the technical advantage, for example, that the components can be assembled easily and precisely.

In another technically advantageous embodiment of the production system, the positioning system comprises positive-locking positioning elements. This provides the technical advantage, for example, of enabling play-free positioning of the components.

In another technically advantageous embodiment of the production system, the positive-locking positioning elements can be latched against one another, pushed in or inserted into one another. This provides the technical advantage, for example, that the components are automatically fixed in the correct position.

In another technically advantageous embodiment of the production system, the positive-locking positioning elements comprise protrusions and/or recesses. This provides the technical advantage, for example, that a particularly precise alignment of the components is achieved.

According to a second aspect, the technical task is solved by a production method for producing partial prostheses, comprising the steps of digitally designing a prosthesis framework with coupling elements to the residual tooth hard tissue by means of a user interface; digitally designing a prosthesis base by means of the user interface; and digitally designing prosthesis teeth by means of the user interface. The production method achieves the same technical advantages as the production system according to the first aspect.

In an advantageous embodiment of the production method, the prosthesis framework, the prosthesis base and/or the prosthesis teeth are automatically produced by a production device. This also provides the technical advantage, for example, that the finished partial prosthesis can be delivered immediately to the dentist for insertion.

In another advantageous embodiment of the production method, the prosthesis framework is produced by a first production unit and the prosthesis base and/or prosthesis teeth are produced by a second production unit. This provides the technical advantage, for example, that the production of the individual parts of the design can be carried out in different production orders depending on the materials to be used. Each part is coupled with the other part and adapted thereto.

In another advantageous embodiment of the production method, data of the designed prosthesis framework, the designed prosthesis base and/or the designed prosthesis teeth are exported via an export interface. This provides the technical advantage, for example, that the data can be further processed by other devices.

In another advantageous embodiment of the production method, a positioning system for positioning the prosthesis framework, the prosthesis base and/or the prosthesis teeth relative to each other is digitally designed via the user interface. This provides the technical advantage, for example, that the components can be assembled in the correct shape in a simple and fast manner.

According to a third aspect, the technical task is solved by a positioning system for positioning a prosthesis framework, a prosthesis base and/or prosthesis teeth relative to each other, with at least one spatial positioning element arranged on the prosthesis framework, the prosthesis base and/or the prosthesis teeth. This provides the technical advantage that the components can be assembled accurately and in the correct shape.

According to a fourth aspect, the technical task is solved by a computer program comprising instructions which, when the computer program is executed by a computer, cause the computer to execute the method according to the second aspect. The computer program achieves the same technical advantages as the production system according to the first aspect. A computer program product includes program code which is stored on a non-transitory machine-readable medium, the machine-readable medium comprises computer instructions executable by a processor, which computer instructions cause the processor to perform the method set forth above.

In a technically advantageous embodiment, the computer program is configured to calculate a suggestion for the spatial shape of the prosthesis framework with coupling elements to the residual tooth hard tissue, a prosthesis base and/or prosthesis teeth. This provides the technical advantage, for example, that the spatial design can be carried out more quickly.

### BRIEF DESCRIPTION OF THE DRAWINGS

Exemplary embodiments of the invention are shown in the drawings and are described in more detail below, in which:

FIG. 1 shows a schematic illustration of a production system for a partial prosthesis;

FIG. 2 shows a schematic illustration of a partial prosthesis;

FIG. 3 shows an enlarged schematic illustration of the partial prosthesis with an illustration of a joining geometry between the prosthesis framework and the prosthesis base;

FIG. 4 shows a further schematic illustration of a partial prosthesis showing a joining geometry between the prosthesis framework and the prosthesis base;

FIG. 5 shows a further schematic illustration of a partial prosthesis showing a joining geometry between a prosthesis framework and a prosthesis base and between a prosthesis base and a tooth portion;

FIG. 6 shows a further schematic illustration of a partial prosthesis showing a joining geometry between the prosthesis framework and the prosthesis base, in which the prosthesis framework in the saddle region has been dispensed with;

FIG. 7 shows a further schematic illustration of a partial prosthesis showing a positioning system;

FIG. 8 shows a further schematic illustration of further partial prostheses showing another positioning system; and

FIG. 9 shows a block diagram of the production method for digital producing partial prostheses.

### DETAILED DESCRIPTION

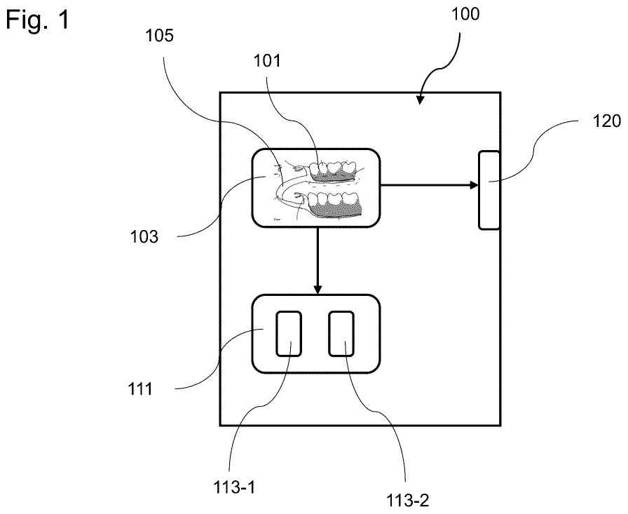

FIG. 1 shows a schematic illustration of a production system 100 for digitally producing a partial dental prosthesis 101. The production system 100 is formed, for example, by a coordinated and adapted CAD/CAM system.

The production system 100 comprises a user interface 103 for digitally designing a prosthesis framework with coupling elements, a prosthesis base, and prosthesis teeth as various components of the partial prosthesis 101. The partial prosthesis 101 can be completely constructed with all components using the digital production system 100. Thus, a highly precise assembly of the components of the partial prosthesis 101 is achieved.

The production system 100 allows the prosthesis teeth of the partial prosthesis 101 to be customized to the patient. This achieves better results than the use of ready-made teeth, as better individuality, function and esthetics are achieved.

Once the components of the partial prosthesis 101 have been digitally designed, they can be produced in an additive or subtractive manner using a production device 111. The production system 100 comprises an export interface 120 for exporting data of the designed prosthesis framework with the coupling elements (model casting framework), the designed prosthesis base (gingiva portion) and/or the designed prosthesis teeth. This allows automatic export for the respective components, prosthesis framework with coupling elements, prosthesis base, prosthesis teeth. Export of combined components to a production device, such as multi-material printing (inkjet printing), is also possible. However, the production device can also use a specially designed blank from which the respective component is milled, such as a two-color or multi-color blank or a multi-material blank.

The production system provides the possibility to produce the different components of the partial prosthesis 101 by means of one or more production units 113-1 and 113-2. Different production processes can be used in the production units 113-1 and 113-2. Generally, the components of the partial prosthesis 101 are produced monolithically from a single piece, subtractively or additively. It is also possible to use only one single production device to produce all components, such as three-dimensional multi-material printing (inkjet printing). This allows the partial prosthetics to be produced efficiently in a single step. However, depending on the component to be produced, different production processes can be used to make the best possible use of the material properties of different production materials.

The prosthesis framework 105 with coupling elements may be made of metal via an additive or subtractive process using a first production unit 113-1. However, the prosthesis framework 105 may also be made of other materials, such as polyetheretherketone PEEK or other high-performance thermoplastic polymers. For the high-performance thermoplastic polymers, inkjet printing requires a separate or special print head with heating elements to bring the material to operating temperature.

Polyetheretherketone is a high-temperature resistant, thermoplastic, semi-crystalline plastic with a melting point of 343° C. and a glass transition temperature of 143° C. The physical, chemical and biological properties of polyetheretherketone enable the production of permanent dental restorations in all ranges of indication. In general, however, other materials are also conceivable.

The prosthesis base and prosthesis teeth can be produced via an additive or subtractive process using a second production unit 113-2. To increase efficiency, a prosthesis base and prosthesis teeth could be produced in a single production step, for example subtractively or additively using at least two colors and two materials in 3D printing.

This can be done in a subtractive production process using a special two-color and/or multi-material blank (ceramic disk). In an additive production process, a three-dimensional multi-color/multi-material printing process is used. Here, at least two materials and two colors are used for the three-dimensional printing process and selectively applied (inkjet process). A further increase in efficiency can be achieved by producing all components in one work step.

Once several components for the partial prosthesis 101 have been produced, they can be easily assembled to form the partial prosthesis. Due to the digital design, the precise assembly of the individual components of the partial prosthesis 101 can be carried out without a model. The fabricated components of the partial prosthesis are joined or bonded using a positioning system. The positioning system is constructed, for example, by plug-in connections and allows model-free and precise assembly of the individual components.

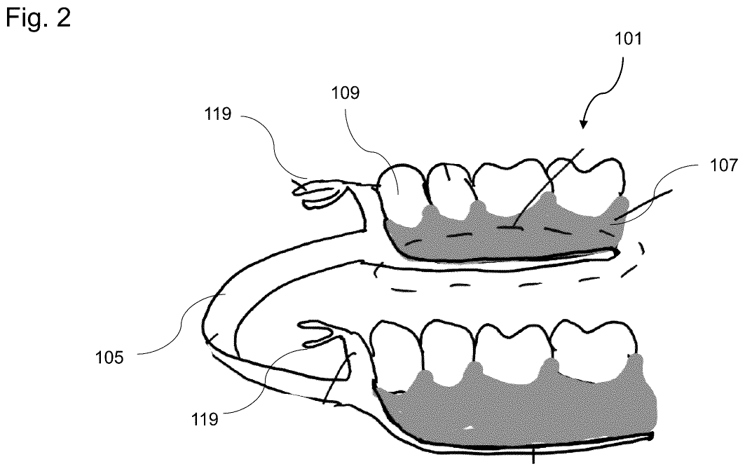

FIG. 2 shows a schematic illustration of a partial prosthesis 101. The partial prosthesis 101 comprises coupling or retaining elements 119 for coupling and supporting the partial prosthesis 101 to the remaining teeth. In addition, the partial prosthesis 101 comprises connecting elements, a prosthesis base 107, and prosthesis teeth 109.

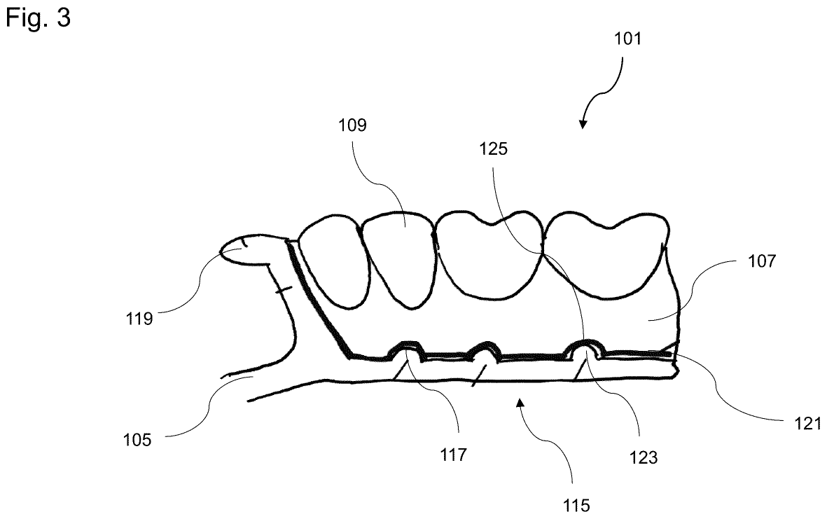

FIG. 3 shows an enlarged schematic illustration of the partial prosthesis 101. The production system 100 is further configured to digitally design a positioning system 115 for positioning the prosthesis framework 105, the prosthesis base 107, and/or the prosthesis teeth 109 relative to each other via the user interface 103.

The positioning system 115 comprises positive-locking positioning elements 117 that can be latched against each other or clicked, pushed or inserted into each other. In this case, the prosthesis framework 105 comprises protrusions 123 as positioning elements 117 that are inserted into corresponding recesses 125 of the prosthesis base 107. A joining medium 121 is located between the positioning element 117 and the prosthesis base 107. The joining medium 121, such as a cement or adhesive, provides the additional chemical bond between the components.

The positioning system 115 can be used to implement a latching or joining system between the prosthesis framework 105, prosthesis base 107 and prosthesis tooth 109 and to work without a model. This achieves a process optimization of the production, for example by omitting an investment model.

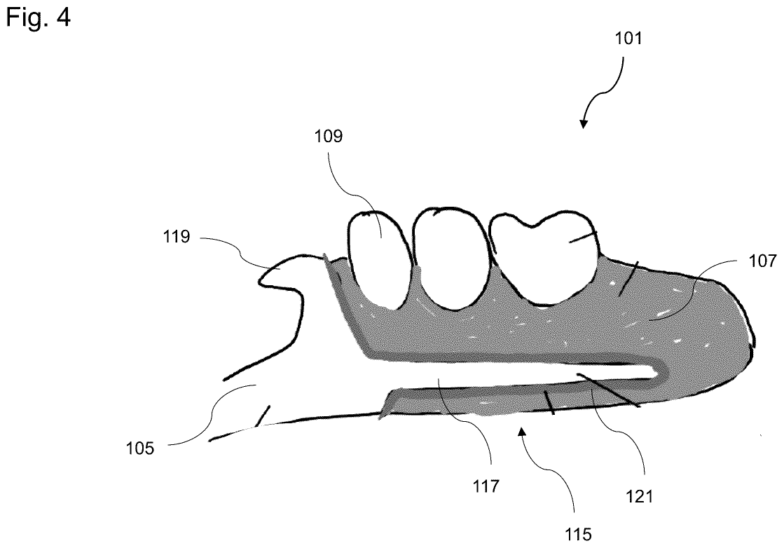

FIG. 4 shows another schematic illustration of a partial prosthesis 101. The partial prosthesis 101 comprises a pin as a positioning element 117 for a prosthesis base 107, which has been produced using a three-dimensional printing process.

The prosthesis base 107 and the prosthesis tooth 109 may also have been milled in one milling step from a two-color pre-designed blank.

For example, the prosthesis base 107 and the prosthesis teeth 109 have been produced using a three-dimensional multi-color/multi-material printing process in a water-soluble support structure. Here, two or more materials and two colors are used for the three-dimensional printing process. Specifically, three materials may be printed to produce the prosthesis base 107. The prosthesis framework can also be formed from plastic and be tooth-colored. Thus, there is no need for an opaquer and there is a chemical bond between all the components of the prosthesis.

A multi-color/multi-material printing process can also be used to produce the entire partial prosthesis 101. In this case, two or more materials and/or two or more colors are used for the three-dimensional printing process and selectively applied (inkjet process). The materials can be colored materials or still be colored with the color print heads. All components can be produced in a single work step and it is possible to combine several different materials.

The pin of the prosthesis framework 117 forms a positioning aid that is inserted into a corresponding recess of the prosthesis base 107. This pin is, for example, of conical design. The design of the positioning aid depends on the requirements of the respective design of the partial prosthesis or the nature of its prosthesis base portion with respect to the patient situation. This also creates a positioning system 115. A joining medium 121 is located between the positioning element 117 and the prosthesis base 107.

For example, a composite-based cement is used as the joining medium 121. The hardening of the cement can be controllable, for example by photopolymerization. In order to cover metal parts of the partial prosthesis 101, the joining medium has a high opacity. In this case, the use of an opaquer can be omitted, thus increasing efficiency in the dental laboratory. The high opacity of the cement means that opaquer firing can be dispensed with.

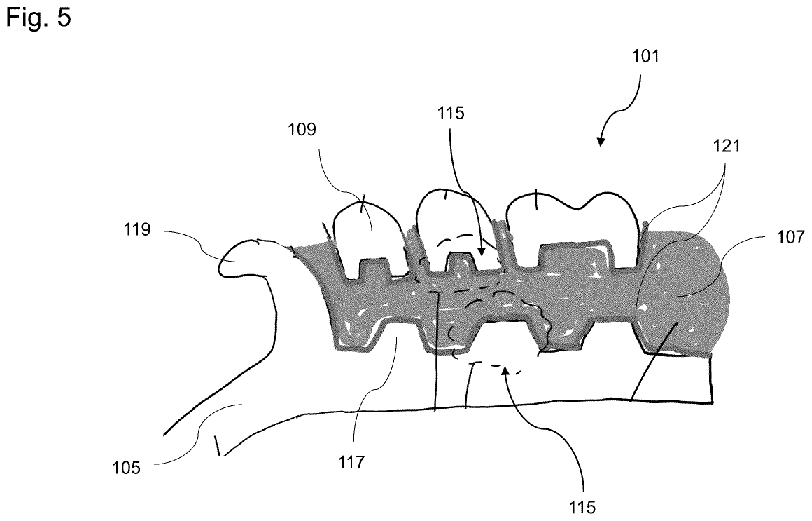

FIG. 5 shows another schematic illustration of a partial prosthesis 101. The partial prosthesis 101 is composed of three components. For example, the prosthesis teeth 109 are formed from milled individual teeth or groups of teeth. A positioning system 115 is arranged both between the prosthesis teeth 109 and the prosthesis base 107 and between the prosthesis base 107 and the prosthesis framework 105. The joining medium 121 is located between the respective components.

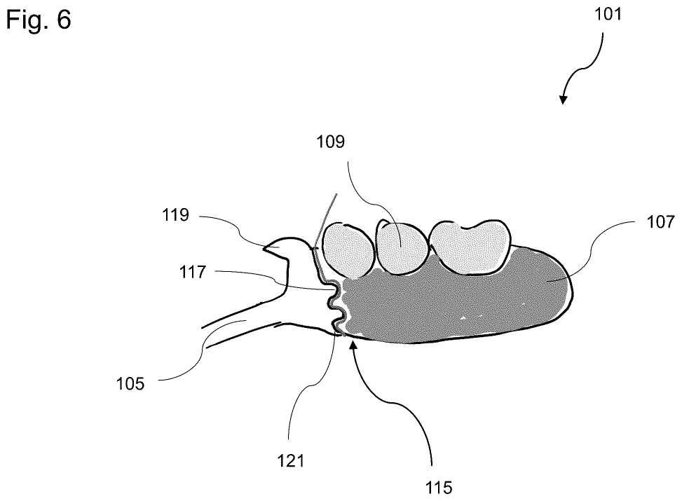

FIG. 6 shows another schematic illustration of a partial prosthesis 101 in which the prosthesis framework 105 is not located below the prosthesis saddle, but is located laterally. The prosthesis framework 105 comprises protrusions that engage corresponding recesses in the prosthesis base to form a spatial positioning system.

The lower pin as a positioning aid can also engage further into the prosthesis base 107. This can ensure better stability. The partial prosthesis 101 also functions without lower reinforcement. This design reduces material costs due to the lower proportion of prosthesis framework material.

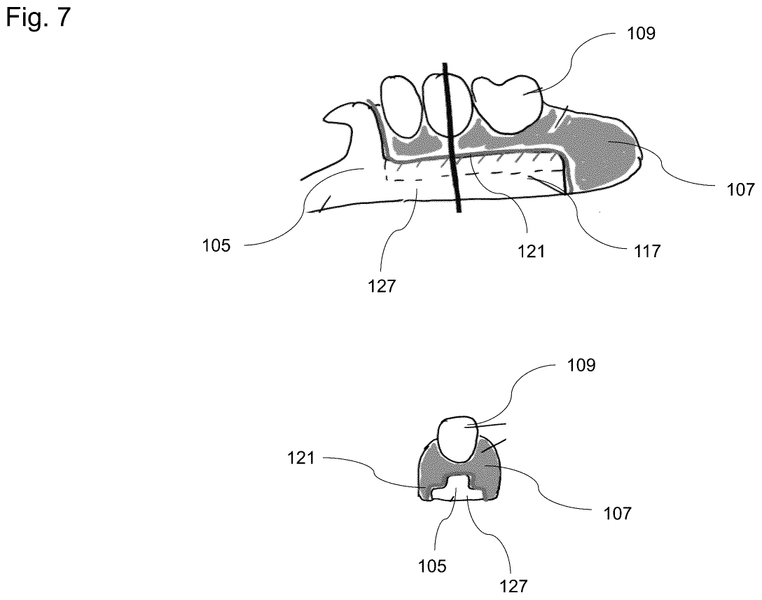

FIG. 7 shows another schematic illustration of a partial prosthesis 101 with an illustration of a positioning system 115. Positioning the prosthesis framework 105 is performed horizontally and/or vertically, laterally, below and/or within the prosthesis base 107 and/or the prosthesis teeth 109. In a model-free fixation of the coupling elements, different geometric shapes can be used, such as a push-button design or Lego brick principle, a plug-in bar or click bar, a bar-shaped or elongated arrangement.

In the case shown, the prosthesis framework 105 comprises a positioning system 115 having a bar 127 as a positioning element 117. The bar has a step structure in cross-section. The bar has a central elevation that is laterally stepped. The prosthesis base 107 has a corresponding recess and is positively put on the bar.

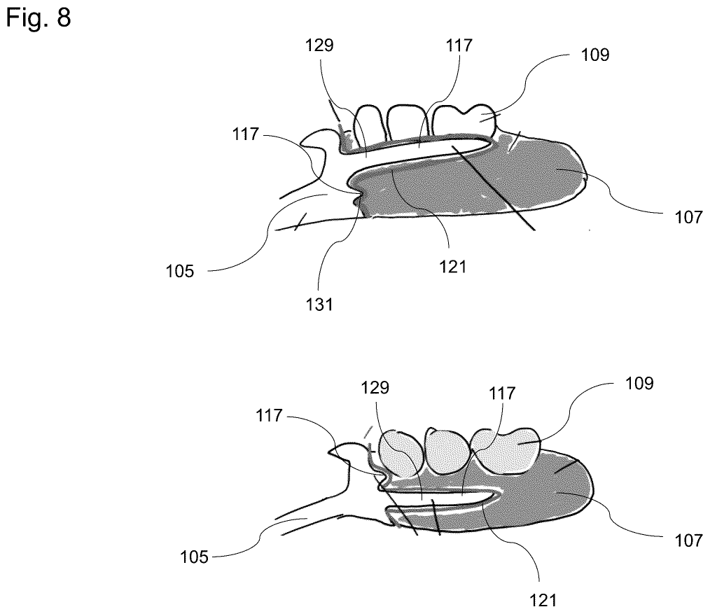

FIG. 8 shows another schematic illustration of partial prostheses 101 showing another positioning system. Positioning can also be performed using one or more pins 129 as positioning element 117 with different lengths. The pin 129 is, for example, conical, round or oval in shape. A two-color blank or a production process using inkjet technology makes it possible to place the positioning elements 117 close together, even in the area of the tooth and prosthesis material. Since no bonding of the dental material to the prosthesis material needs to take place after separate production, a stable system is present. By combining tooth material and prosthesis material, minimum wall thicknesses can be created together. In addition, this opens up degrees of freedom for special patient situations. The positioning system 115 enables a highly precise connection by means of a positive and/or frictional connection, especially when using the joining medium 121.

In addition, adhesive channels can be introduced during designing so that when the prosthesis framework is pushed into the prosthesis base and/or prosthesis teeth, the excess adhesive material can drain off through the adhesive channels and the insertion of the prosthesis framework can be easily performed. This would also prevent bubbles in the adhesive material.

In general, the partial prosthesis 101 may comprise a positioning system 115 for positioning a prosthesis framework 105, a prosthesis base 107, and/or prosthesis teeth 109 relative to each other, having at least one spatial positioning element 117 arranged on the prosthesis framework 105, the prosthesis base 107, and/or the prosthesis teeth 109.

The positioning element 117 is, for example, a pin 129 or a bar 127 formed on the prosthesis framework 105. In addition to the pin 129 or bar 127, the prosthesis framework 105 may comprise a protrusion 131 onto which a recess in the prosthesis base 107 and/or the prosthesis teeth 109 is pushed, for example, when pushed onto the pin 129 or bar 127. The prosthesis base 107 and/or the prosthesis teeth 109 may comprise a recess to receive the pin 129 or bar 127. This recess may extend along a row of teeth. The pin or bar may have an oval, rectangular, square, or step-shaped cross-section.

The positioning element 117 may be formed by a protrusion or recess in the prosthesis framework 105, the prosthesis base 107, and/or the prosthesis teeth 109. The protrusion or recess may have a conical or cylindrical shape. The positioning elements 117 can each be arranged on different components of the partial prosthesis 101, such as the prosthesis framework 105, the prosthesis base 107 and/or the prosthesis teeth 109. Two positioning elements 117 in each case can interact in a positive or frictional manner.

For example, the positioning system 115 comprises a joining medium 121 for connecting the prosthesis framework 105, the prosthesis base 107, and/or the prosthesis teeth 109. For example, the joining medium 121 is opaque, non-transparent, or impervious to light. In addition, a method for positioning a prosthesis framework 105, a prosthesis base 107, and/or prosthesis teeth 109 relative to each other may comprise the step of positioning by means of at least one spatial positioning element 117 arranged on the prosthesis framework 105, the prosthesis base 107, and/or the prosthesis teeth 109.

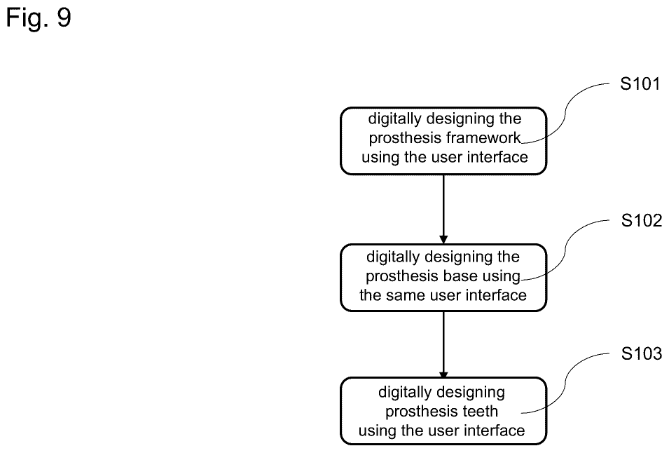

FIG. 9 shows a block diagram of the production method with models or for model-free production of partial prostheses 101. After taking an impression of the residual dentition situation and determining the jaw relationship, the partial prosthesis is designed on the basis of the digitally acquired data.

The production method for the partial prosthesis 101 comprises the step S101 of digitally designing the prosthesis framework 105 using the user interface 103; the step S102 of digitally designing the prosthesis base 107 using the same user interface 103; and the step S103 of digitally designing prosthesis teeth 109 using the user interface 103. The user interface 103 comprises, for example, a display with control device, such as a mouse. Through the user interface 103, a user can interact with the production system 100 to design the prosthesis framework 105, the prosthesis base 107, and/or the prosthesis teeth 109 in a digital environment in terms of space and color.

All components of the partial prosthesis 101 can be designed in a single work step. In this way, importing or exporting different design elements and using different software with different interfaces can be avoided.

For an analysis of gap dentition and a correct arrangement of retaining and coupling elements 119 or a spatial design of the partial prosthesis 101 and/or the components, a computer program may be used that uses an artificial intelligence algorithm for this purpose. The artificial intelligence algorithm may comprise, for example, an artificial neural network that has been taught with a plurality of training data. In this regard, the training data comprises, for example, data on a spatial shape of the dental arch and the residual teeth, each of which is assigned a spatial shape of the partial prosthesis 101 and the components. If the artificial neural network is trained with this training data, it can then automatically calculate a spatial shape of the partial prosthesis 101 and the components based on the spatial shape of the dental arch and the residual teeth. This shape can be presented to the user as a suggestion.

In this way, user errors in planning can be reduced. In connection with the positioning system 115, the computer program can analyze the arrangement of the positioning elements 117 in connection with the infinite possibilities of framework designs and automatically calculate and suggest designs of the partial prosthesis 101. The computer program may be executed on a computer having a processor and a digital memory for storing the computer program and other data.

The automated production process with subsequent possible model-free combination of the components significantly simplifies the production process for partial prostheses 101. The automated design and production process for partial prostheses 101 is achieved by software that combines all design elements and functions for the components of the partial prosthesis 101. The software (computer program) can be executed on a suitable computer, which thereby forms the production system 100.

The production method achieves an automated design and production process for partial prostheses. The components of the partial prosthesis 101 can be produced from one piece (monolithically), subtractively and/or additively. As a result, a highly accurate model-free assembly of the components of the partial prosthesis 101 is achieved. In addition, a positioning system 115 is used for the individual components.

The individual components can be generated by controlling different materials. Corresponding data sets for the respective components adapt to each other so that they do not have to be split or separated from each other. The digital design of a positioning system facilitates assembling and joining the components.

In some embodiments, computer memory is intended to refer to a non-transitory and tangible computer product that can store and communicate executable instructions for the implementation of various steps of the methods disclosed herein. The computer readable memory can be any computer data storage device or assembly of such devices including, for example: a temporary storage unit such as a random-access memory (RAM) or dynamic RAM; a permanent storage such as a hard disk; an optical storage device, such as a CD or DVD (rewritable or write once/read only); a flash memory; and/or other non-transitory memory technologies. A plurality of such storage devices may be provided, as can be understood by those skilled in the art. The computer readable memory may be associated with, coupled to or included in a computer configured to execute instructions stored in the computer readable memory in connection with various functions associated with the computer.

In some embodiments, computer refers broadly to any computing or processing unit or device including electronic circuitry that can control and execute, at least partly, instructions required to perform various steps of the method disclosed herein. The computer can be embodied by a general purpose computer, a central processing unit (CPU), a microprocessor, a microcontroller, a processing core, or any other processing resource or any combination of such computer or processing resources configured to operate collectively as a processing unit.

All of the features explained and shown in connection with individual embodiments of the invention may be provided in different combinations in the subject matter of the invention to simultaneously realize their beneficial effects.

All method steps can be implemented by devices which are suitable for executing the respective method step. All functions that are executed by the features of the subject matter can be a method step of a method.

The scope of protection of the present invention is given by the claims and is not limited by the features explained in the description or shown in the figures.

### REFERENCE LIST

100 Production system
101 Partial prosthesis
103 User interface
105 Prosthesis framework
107 Prosthesis base
109 Prosthesis teeth
111 Production device
113 Production unit
115 Positioning system
117 Positioning element
119 Coupling or retaining elements
120 Export Interface
121 Joining medium
123 Protrusion
125 Recess
127 Bar
129 Pin
131 Protrusion

1. A production system for digitally producing partial prostheses, comprising:
a user interface for digitally designing a prosthesis framework with coupling elements to residual tooth hard tissue, a prosthesis base and prosthesis teeth.

2. The production system as claimed in claim 1, comprising
a production device for automatically producing the prosthesis framework, the prosthesis base and/or the prosthesis teeth.

3. The production system as claimed in claim 2,
wherein the production device is configured to produce the prosthesis framework, the prosthesis base and/or the prosthesis teeth by an additive and/or subtractive production process.

4. The production system as claimed in claim 3,
wherein the production device comprises a first production unit for producing the prosthesis framework and a second production unit for producing the prosthesis base and/or the prosthesis teeth, or
the production device is configured to produce the prosthesis framework, the prosthesis base and/or the prosthesis teeth by a single production unit.

5. The production system as claimed in claim 1, comprising
an export interface for exporting data of the designed prosthesis framework, the designed prosthesis base and/or the designed prosthesis teeth.

6. The production system as claimed in claim 1,
wherein the production system is configured to digitally design a positioning system for positioning the prosthesis framework, the prosthesis base and/or the prosthesis teeth relative to each other via the user interface.

7. The production system as claimed in claim 6,
wherein the positioning system comprises positive-locking positioning elements.

8. The production system as claimed in claim 7,
wherein the positive-locking positioning elements can be latched against, pushed into, or inserted into one another.

9. The production system as claimed in claim 8,
wherein the positive-locking positioning elements comprise protrusions and/or recesses.

10. A production method for producing partial prostheses, comprising the steps of:
digitally designing a prosthesis framework with coupling elements to the residual tooth hard tissue with a user interface;
digitally designing a prosthesis base with the user interface; and
digitally designing prosthesis teeth with the user interface.

11. The production method as claimed in claim 10,
wherein the prosthesis framework, the prosthesis base and/or the prosthesis teeth are automatically produced by a production device.

12. The production method as claimed in claim 11,
wherein the prosthesis framework is produced by a first production unit and the prosthesis base and/or the prosthesis teeth (109) are produced by a second production unit.

13. The production method as claimed in claim 10,
wherein data of the designed prosthesis framework, the designed prosthesis base and/or the designed prosthesis teeth are exported via an export interface.

14. The production method as claimed in claim 10,
wherein a positioning system for positioning the prosthesis framework, the prosthesis base and/or the prosthesis teeth relative to each other is digitally designed via the user interface.

15. A positioning system for positioning a prosthesis framework, a prosthesis base and/or prosthesis teeth relative to each other, comprising:
at least one spatial positioning element arranged on the prosthesis framework, the prosthesis base and/or the prosthesis teeth.

16. A computer program product comprising
program code which is stored on a non-transitory machine-readable medium, the machine-readable medium comprising computer instructions executable by a processor, which computer instructions cause the processor to perform the method according to claim 10.

17. The computer program as claimed in claim 16,
wherein the computer program product is configured to calculate a suggestion for the spatial shape of the prosthesis framework with coupling elements to the residual tooth hard tissue, a prosthesis base and/or prosthesis teeth.
